(19) United States
(12) Patent Application Publication
(10) Pub. No.: US 2006/0116085 A1
(43) Pub. Date: Jun. 1, 2006

(54) VLIF transmitter for Bluetooth

(75) Inventors: Marc Borremans, Korbeek-Dijle (BE); Paul Goetschalckx, Sint-Katelijne-Waver (BE); Andrea Monterastelli, Lucca (IT)

Correspondence Address: STMicroelectronics Inc.;c/o WOLF, GREENFIELD & SACKS, PC, Federal Reserve Plaza, 600 Atlantic Avenue, BOSTON, MA, 02210-2206, US

(73) Assignee: STMicroelectronics Belgium N.V., Zaventem (BE)

(21) Appl. No.: 11/227,234

(22) Filed: Sep. 15, 2005

(30) Foreign Application Priority Data
Sep. 15, 2004 (EP) 04077551.2

(51) Int. Cl. H04B 1/02

(52) U.S. Cl. 455/91

(57) ABSTRACT

An RF transmitter suitable for Bluetooth transmissions has an IF modulator and an RF modulator, the IF modulator being arranged to use a very-low-IF-frequency, smaller than half the channel bandwidth, such that spurious unwanted modulation components fall in other channels having a channel number within one or two of a channel being transmitted. This can reduce the VCO pulling problem and reduce adjacent channel power degradation compared to using higher IF frequencies. The local oscillator PLL's fractionality is used in order to optimize the adjacent power frequency plan by selecting the most appropriate IF frequency. For the Bluetooth application, the IF frequency is <500 kHz, and the main non-filtered spurious components (1LO·xBB with x: −3, −2, . . . , +3) image, carrier, pulling, for both 0 and 1 FM signals, are positioned in frequency bands of adjacent channels.

### BACKGROUND OF THE INVENTION

1. Field of the Invention

This invention relates to RF transmitter devices, to transceivers, to integrated circuits, portable devices having such transmitters, and to methods of producing signals using such transmitters.

2. Discussion of the Related Art

A number of known radio systems use transmissions at the same frequency or different frequencies in different time slots. Frequency domain/time-division-multiple-access (FDMA-TDMA) systems include Digital European Cordless Telecommunications (DECT), Global System for Mobile Communications (GSM), and Bluetooth. Bluetooth is a well known short-range radio link intended to replace the cable(s) connecting portable and/or fixed electronic devices. Full details are available from Bluetooth SIG which has its global headquarters in Overland Park, Kans., USA. Key features are robustness, low complexity, low power, and low cost. Bluetooth operates in the unlicensed ISM band at 2.4 GHz. A frequency hop transceiver is applied to combat interference and fading. A time slotted channel is applied with a nominal slot length of 625 μs. 79 channels are used, with 1 MHz per channel (2.402, 2.403, . . . , 2.480 GHz). On each channel, information is exchanged through packets. Each packet is transmitted on a different hop frequency. The Bluetooth protocol uses a combination of circuit and packet switching. Slots can be reserved for synchronous packets. The Bluetooth system can provide a point-to-point connection (only two Bluetooth units involved), or a point-to-multipoint connection. Bluetooth transmitters hop from one RF frequency to another many times a second and have a short time to settle at the new frequency.

Suitable RF transmitters can be integrated using a number of different topologies. These topologies can be distinguished based on the implementation of the main functionalities:

1) Generation of a modulated digital base-band signal, or modulation of a local oscillator signal with the base-band signal (e.g. direct VCO modulation or IQ modulation).

2) Generation of a local oscillator signal.

3) The type of power amplifier used.

For an IQ modulation topology and where the local oscillator is at the application's channel center frequency, the RF output component is near to the LO frequency, which can result in a frequency pulling of the local oscillator.

For this reason often an oscillator at double the channel frequency is used in combination with a divide-by-2 circuit. However, also in this topology, frequency pulling appears due to coupling of the second harmonic components of the RF signal to the oscillator. It is known to avoid this RF coupling from the transmitter to oscillator that causes the pulling of the oscillator, by choosing a different topology. For a simple frequency modulation, a direct modulation of the LO could be selected avoiding this pulling problem. For an IQ modulation topology, it is known in literature, that the pulling effect is reduced when the frequency difference between the oscillator frequency and the injected component (coupling from the transmitter output) is increased. Therefore, the pulling can be reduced by using an intermediate frequency topology.

Solutions based on an intermediate frequency and on using filters to eliminate image and other distortion components have a severe drawback for integration. These filters require expensive external components and are not suited for low-cost on-chip integration. An alternative exists in using an intermediate frequency at a low multiple of the channel bandwidth or at a multiple of half the channel bandwidth. In this case, any IF harmonic distortion components, carrier component (spurious components) are not filtered and degrade the adjacent channel power performance. The position of these components in the TX output spectrum depend on the choice of IF frequency.

### SUMMARY OF THE INVENTION

An object of the invention is to provide improved apparatus or methods especially for RF transmitter devices, RF transceivers, integrated circuits for RF devices, portable devices having such transmitters, and methods of producing signals using such transmitters.

According to a first aspect, the invention provides an RF transmitter having an IF modulator for generating an IF modulated signal, and an RF modulator, the RF modulator being arranged to generate RF signals on a number of frequency channels, from the IF modulated signal, the IF modulator being arranged to use a Very-Low-IF-frequency f_{IF}, smaller than half the channel bandwidth and larger than zero.

The use of a Very-Low-Intermediate-Frequency transmitter with a Very-Low-IF-frequency f_{IF} smaller than half the channel bandwidth: 0<f_{IF}<BW/2 can help enable a good margin on adjacent channel power and a reduced pulling effect on the local RF oscillator to be achieved. It can also enable more complex modulation schemes compared to direct modulation topologies.

An additional feature of the present invention is a fractional PLL circuit for generating the RF local oscillator signal for the RF modulation. For example, the LO frequency can be compensated for this f_{IF} in the fractional PLL. If the IF is e.g. 420 kHz and the channel frequency is at e.g. 2402 MHz, the LO frequency is at 2402 MHz−430 kHz=2401.57 MHz. The oscillator is set to oscillate at this frequency or at twice this frequency for the double frequency+div-by-2 topology. This change in frequency is implemented by a different control input of a fractional PLL.

Another additional feature is the channel bandwidth being 1 MHz or less. Comparing Table 1 with FIG. 4 below shows that for the example of Bluetooth, an IF frequency smaller than 500 kHz i.e. channel BW/2, the main distortion components image, carrier, pulling for both 0 and 1 frequency modulated signal are in a part of the spectrum with a more relaxed adjacent channel power specification with M=2 (20 dBm).

Another additional feature is the f_{IF} being selected such that spurious components at frequencies based on integer multiples of a baseband frequency, in an RF output spectrum, are positioned in a frequency band of an adjacent channel. In particular, such spurious components (1LO·xBB with x: −3, −2, . . . , +3) in an RF output spectrum are positioned in a frequency band with less stringent specifications for adjacent channel power.

Another additional feature is the transmitter being a Bluetooth transmitter. Another additional feature is the transmitter being incorporated in a transceiver IC with digital baseband processing, digital baseband modulation and demodulation functions, an analog IF section and RF modulation and demodulation functions.

Another aspect of the invention is an integrated circuit for an RF transmitter. Another aspect is a portable wireless product having the transmitter. Another aspect of the invention is a method of producing signals using the transmitter. Another aspect provides an RF transmitter suitable for Bluetooth transmissions and having an IF modulator for generating an IF modulated signal, and having an RF modulator, the RF modulator being arranged to generate RF signals on a number of frequency channels, from the IF modulated signal, the IF modulator being arranged to use a very-low-IF-frequency f_{IF}, such that main or significant spurious unwanted modulation components, e.g. at f_{LO}·xf_{BB} [x: −3 . . . 3], fall in channels having a channel number smaller than (i.e. within) three of a channel being transmitted, e.g. zero, one or two channel numbers away.

Embodiments of the invention can combine easier integration and reduction of the pulling effect with an increased margin on the adjacent channel power specification compared to using an intermediate frequency at a low multiple of the channel bandwidth or at a multiple of half the channel bandwidth. Particularly for the Bluetooth application, the choice of IF frequency in combination with the channel frequency plan can give the advantage that the main non-filtered spurious components (1LO·xBB with x: −3, −2, . . . , +3) in the TX output spectrum are positioned in the frequency bands with the least-stringent specifications for adjacent channel power.

To reduce the VCO pulling problem and to overcome the adjacent channel power degradation when using a (half-)channel BW multiple as IF frequency, the PLL's fractionality is used in order to optimize the adjacent power frequency plan by selecting the most appropriate IF frequency.

This can give significant improvement of the pulling compared to zero-IF (experiments showed a 10 to 15 dB improvement). Significant improvement of the margin on adjacent channel power for specific distortion components can arise because these components are located in a channel with 20 dB less stringent specifications. (So for same TX output power, 20 dB more margin).

Any of the additional features can be combined together and combined with any of the aspects. Other advantages will be apparent to those skilled in the art, especially over other prior art. Numerous variations and modifications can be made without departing from the claims of the present invention. Therefore, it should be clearly understood that the form of the present invention is illustrative only and is not intended to limit the scope of the present invention.

### BRIEF DESCRIPTION OF THE DRAWINGS

How the present invention may be put into effect will now be described by way of example with reference to the appended drawings, in which:

FIG. 1 shows a transmitter according to an embodiment of the invention,

FIG. 2 shows for reference a graph of a TX output spectrum for 0/1 (FM modulated) data at 0 kHz IF, that is direct modulated, where channel bandwidth is 1 MHz,

FIG. 3 shows for reference a graph of a TX output spectrum for 0/1 (FM modulated) data at 1000 kHz IF, again where channel bandwidth is 1 MHz and

FIG. 4 shows a graph of a TX output spectrum for 0/1 (FM modulated) data at 450 kHz IF (less than half the channel bandwidth) according to an embodiment of the invention.

### DESCRIPTION OF THE PREFERRED EMBODIMENTS

The present invention will now be described with reference to certain embodiments and with reference to the above mentioned drawings. Such description is by way of example only and the invention is not limited thereto.

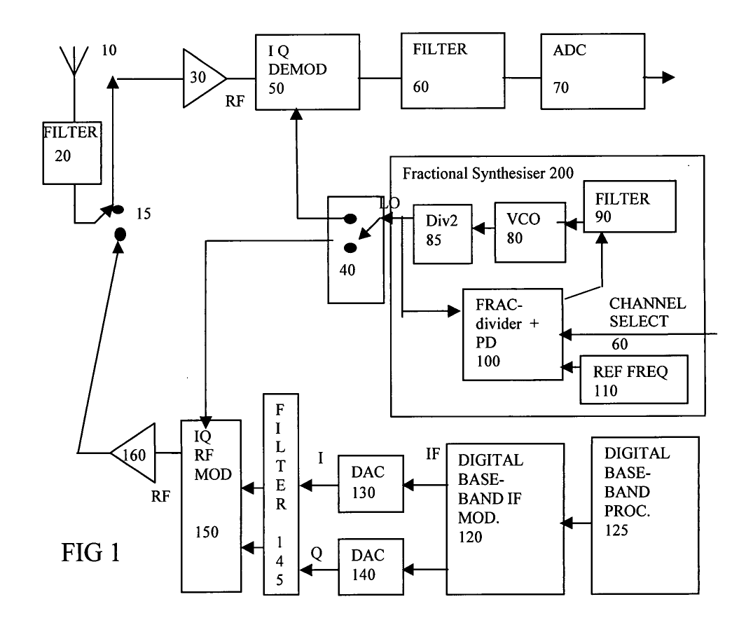

A first embodiment of the invention, illustrated in FIG. 1 shows an example of a transceiver having a transmitter according to an embodiment of the invention. It is suitable for Bluetooth or similar wireless specifications. Such description is by way of example only and the invention is not limited thereto. It will be noted, however, that all the embodiments of the present invention can be used with the Bluetooth™ protocol. The features of such a system may include one or more of:
Slow frequency hopping as a spread spectrum technique;
Master and slave units whereby the master unit can set the hopping sequence;
Each device has its own clock and its own address;
The hopping sequence of a master unit can be determined from its address;
A set of slave units communicating with one master all have the same hopping frequency (of the master) and form a piconet;
Piconets can be linked through common slave units to form a scatternet;
Time Division Multiplex Transmissions (TDMA) between slave and master units;
Time Division Duplex (TDD) transmissions between slaves and masters units;
Transmissions between slave and master units may be either synchronous or asynchronous;
Master units determine when slave units can transmit;
Slave units may only reply when addressed by a master unit;
The clocks are free-running;
Uncoordinated networks, especially those operating in the 2.4 GHz license-free ISM band;
A software stack to enable applications to find other Bluetooth™ devices in the area;
Other devices are found by a discovery/inquiry procedure; and
Hard or soft handovers.

With regard to frequency hopping, “slow frequency hopping” refers to the hopping frequency being slower than the modulation rate, “fast frequency hopping” referring to a hopping rate faster than the modulation rate. The present invention is not limited to either slow or fast hopping.

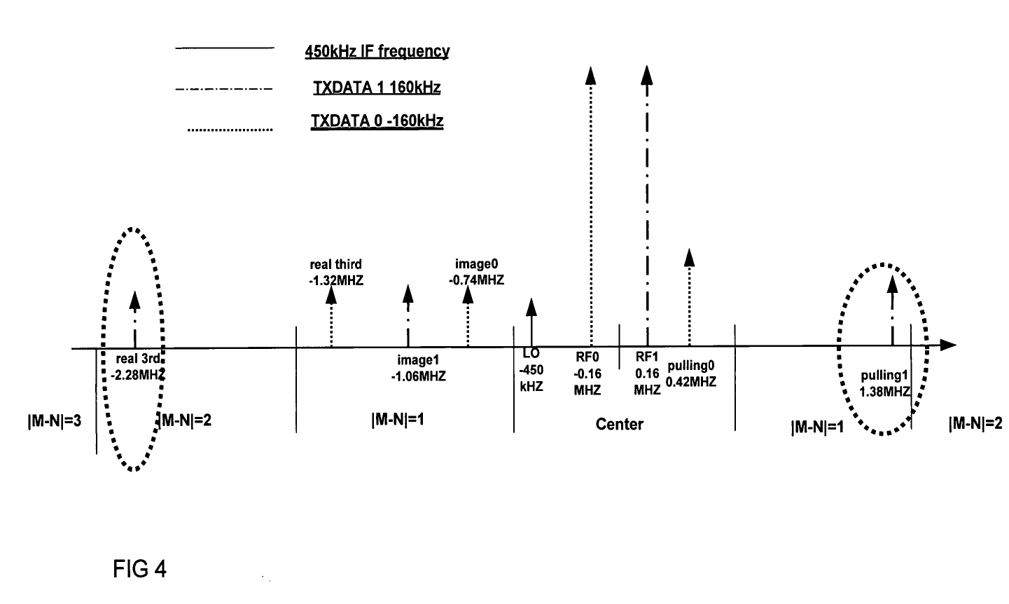

Returning to FIG. 1, the transmitter includes an optional digital base band processing part 125, for generating the data to be transmitted. This is passed to an IF modulator part 120 for modulating the data with a very low frequency IF frequency to produce an IF signal. In this case, the modulation is achieved in the digital domain and produces I and Q outputs, though other schemes are possible. As described in more detail below with reference to FIG. 4, the IF frequency is chosen to be less than half the channel bandwidth. This enables spurious components to be located in more favorable parts of the spectrum, closer to the desired signal. This is more favorable because standards such as the Bluetooth standard specify that more cross channel interference can be tolerated between channels closer together.

The IF I and Q signals are converted to analog signals by DACs 130 and 140 respectively and optionally filtered. For example, these analog signals are first filtered at 145 to remove the DAC alias and other high frequency components thus preventing these from being modulated to RF frequency, and are then fed to the RF modulator 150 to produce RF signals. These are amplified by power amplifier 160 and fed via switch 15 and an external band filter filter 20 in the common Receive-Transmit signal path to antenna 10. The RF modulator uses a local oscillator signal LO which has a frequency which determines which channel is transmitted. The local oscillator generator (also called a synthesizer) typically has a fractional phase lock loop PLL 200. A fractional PLL is often preferred to a synthesizer having an integer-N type PLL, which switches frequencies by integer multiples of the internal reference frequency (FREF) 110. This FREF is usually generated by dividing down a crystal oscillator using a reference divider located prior to an analog phase detector. In the integer-N system, the analog phase detector of the PLL compares two inputs, FREF and an integer-N divider output, which is the divided down voltage-controlled oscillator (VCO 80) output frequency. The phase detector adjusts the voltage to the VCO until both inputs are equal in phase or phase-locked. In case of a VCO running at twice the LO frequency a divide-by-2 circuit 85 is used. To generate a desired VCO frequency, the integer-N divider divides the VCO frequency by a value (N). To generate an output frequency of 1000 MHz with a step size of 1 MHz, FREF is 1 MHz (FREF is equal to step size in an integer-N synthesizer) and N is 1,000. To achieve a finer step size without poor phase noise characteristics, a fractional PLL is used. Instead of having an integer-N divider, the frac-N PLL has a fractional-N divider. A loop filter 90 is also included to help make frequency changes more stable, when the channel is changed, controlled by a channel select signal from control circuitry (not shown). A useful reference for PLL's is the book by R. E. Best, “Phase-Locked Loops” Fifth Edition, McGraw-Hill, 2003.

An optional div/2 block 85 is provided after the VCO 80. The optional div2 block is in case a double frequency VCO is used.

On the receive side, the switch 15 sends received RF signals through a filter 20, a low noise amplifier 30, to an IQ demodulator 50. This uses the local oscillator signal LO, fed by switch 40. The demodulated outputs are fed via filter 60 to ADC 70. Optionally the digital signals from the ADC may be fed to further demodulation circuitry depending on the application, or to further processing stages. The transceiver can be integrated entirely in a single IC, or divided across multiple ICs as desired. It can be incorporated in wireless mobile devices such as battery powered mobile telephones or mobile computing or display or multimedia devices for example.

TABLE 1
Requirements on adjacent channel
power for the Bluetooth standard.
Bluetooth spectral density specifications

Channel |M − N| = 0
20 dBc BW < +/−500 kHz from the 20 dB BW test
Channel |M − N| = 1
No spec from adjacent channel power
Spec implied by the 20 dBc from the 20 dB BW test
Channel |M − N| = 2:
P <− 20 dBm
From adjacent channel power spec
Channel |M − N| > 2
P <− 40 dBm
From adjacent channel power spec

This table shows the amount of spurious power from adjacent channels which can be tolerated. When the channel number differs by 1, (M−N=1) then more spurious power can be tolerated. When the channel number differs by more than 2, there is less tolerance for spurious power. The embodiments described below exploit this insight by arranging the IF frequency so that unwanted artifacts in the spectrum fall into adjacent channels where M−N is 1 or 2 so that there is more tolerance for them, and less need to suppress such artifacts.

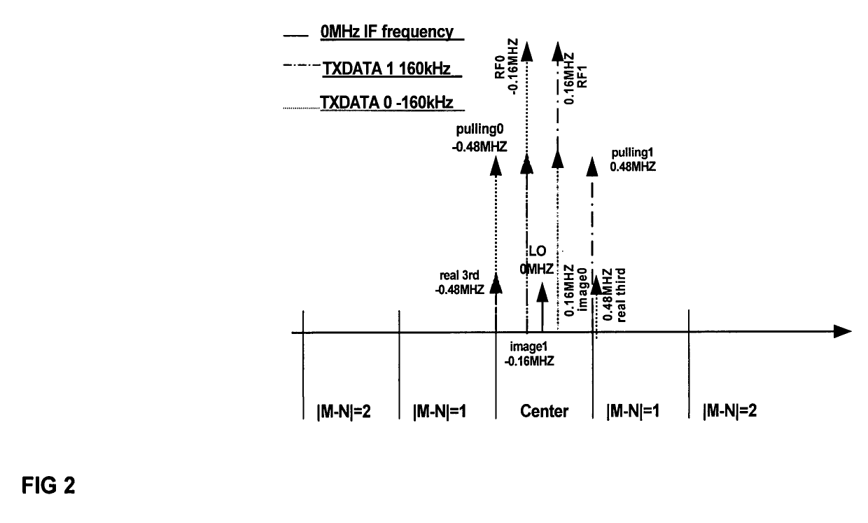

FIG. 2 is included for reference and shows a problem with a known arrangement using a direct conversion (IF=0 Hz) transmitter topology with no IF modulator. It shows a graph of a transmitter output frequency spectrum for 0/1 (FM modulated) data where there is no IF modulator, in other words, IF=0 kHz. The simplified schematic graph shows the main spurious components at 1LO·xBB (x: −3 . . . +3). The output is symmetric around the channel center for 0/1 data. The indicated frequency offsets are relative to the channel center. The pulling and the image components are assumed to be caused by parasitic coupling from the transmitter to the oscillator. This is exacerbated by use of highly integrated devices with more components on the same substrate.

The nomenclature used is for the spurs is as follows:

| Name | Line | Frequency | Txdata | Remark |
|---|---|---|---|---|
| RF0 | Gray | Channel center − f_{BB} = | Contin- | Wanted signal |
| | | f_{LO} + f_{IF} − f_{BB} | uous 0 | |
| RF1 | Black | Channel center + f_{BB} = | Contin- | Wanted signal |
| | | f_{LO} + f_{IF} + f_{BB} | uous 1 | |
| LO | Black | Channel center − | | Carrier |
| | | f_{IF} = f_{LO} | | |
| Imaqe0 | Gray | f_{LO} − (f_{IF} − f_{BB}) | Contin- | Normally rejected by |
| | | | uous 0 | IQ modulation, value |
| | | | | determined by on-chip |
| | | | | matching accuracy but |
| | | | | can be dominated by |
| | | | | VCO pulling |
| | | | | component |
| Image1 | Black | f_{LO} − (f_{IF} + f_{BB}) | Contin- | Idem |
| | | | uous 1 | |
| Real | Gray | f_{LO} − 3.(f_{IF} − f_{BB}) | Contin- | Main distortion |
| third | | | uous 0 | component due to non |
| | | | | linearity of the mixer |
| | | | | and/or the analog |
| | | | | baseband. |
| Real | Black | f_{LO} − 3.(f_{IF} + f_{BB}) | Contin- | Idem |
| third | | | uous 1 | |
| Pulling0 | Gray | f_{LO} + 3.(f_{IF} − f_{BB}) | Contin- | Normally rejected by |
| | | | uous 0 | the IQ modulation, but |
| | | | | a dominant component |
| | | | | in case of VCO pulling |
| Pulling1 | Black | f_{LO} + 3.(f_{IF} + f_{BB}) | Contin- | Idem |
| | | | uous 1 | |

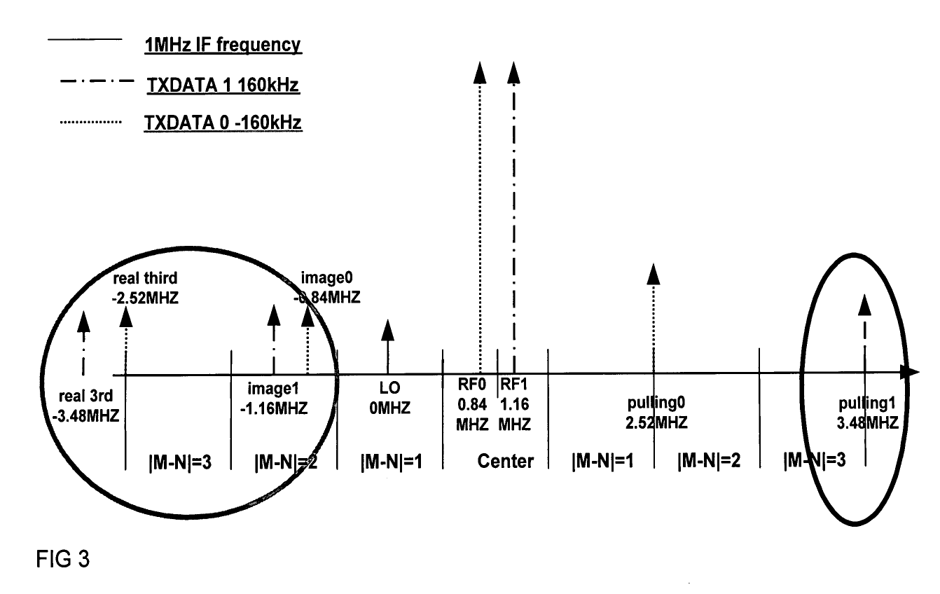

FIG. 3 shows a similar graph of transmitter output spectrum for 0/1 (FM modulated) data, but this time at a higher IF of 1000 kHz, which corresponds to a value equal to the channel bandwidth. It shows a simplified schematic of the main spurious components at 1LO·xBB (x: −3 . . . +3). The indicated frequency offsets are relative to the LO frequency. To get the offset relative to the channel center, 1 MHz has to be subtracted from each number. The output is no longer symmetric around the channel center for 0/1 data. The pulling and the image components are signifficantly reduced by the frequency offset between the frequency of the oscillator and the 2 Rf frequency. However several spurious distortion components are positioned in the frequency band where the −40 dBm adjacent power specification applies. These are circled in the figure for emphasis. These are the channels where the difference between channel numbers M−N is greater than two. These unwanted distortion components need to be suppressed. The image components have also been circled to indicate that for higher IF frequency (>1.5 MHz) these are also located outside the intended band with [M−N]<3.

FIG. 4 shows a similar graph of transmitter output spectrum for 0/1 (FM modulated) data, but for an embodiment of the invention, where IF=450 kHz, in other words the IF is less than half the channel bandwidth. It shows a simplified schematic of the main spurious components at 1LO·xBB (x=−3, −2, . . . +3), superimposed on the Bluetooth channel allocation. The indicated frequency offsets are relative to the channel center. As in FIGS. 2 and 3, the lighter arrows represent the desired and unwanted components from the transmission of a “zero”. The zeroes are transmitted at 160 kHz below the channel centre frequency, set by the LO. The darker arrows represent desired and unwanted components from the transmission of a “one”. The ones are transmitted at 160 kHz above the center frequency. The output is not symmetric around the channel center for 0/1 data. The pulling and the image components are still significantly reduced by the frequency offset between oscillator and the 2 RF frequency. The spurious distortion components are NOT positioned in the frequency band where the −40 dBm adjacent power specification applies, but in a band where more relaxed specifications apply. Thus these components need not be suppressed as much as the corresponding components shown in FIG. 2.

The circuitry can be implemented in conventional hardware and use integrated circuit technology following established practice which need not be described here in more detail. Digital processing parts can be implemented using application specific logic or software running on processing circuitry, the software being written in a conventional language. Although described for wireless applications transmitting through air, RF transmitters can also be used for transmitting along waveguides.

As has been described above, an RF transmitter suitable for Bluetooth transmissions has an IF modulator (120) and an RF modulator (150), the IF modulator being arranged to use a very-low-IF-frequency f_{IF}, smaller than half the channel bandwidth, such that spurious unwanted modulation components fall in other channels having a channel number within one or two of a channel being used for transmission. This can reduce the VCO pulling problem and reduce adjacent channel power degradation compared to using higher IF frequencies. The local oscillator PLL's fractionality is used in order to optimize the adjacent power frequency plan by selecting the most appropriate IF frequency. For the Bluetooth application, the IF frequency is <500 kHz, and the main non-filtered spurious components (1LO·xBB with x: −3, −2, . . . , +3) image, carrier, pulling, for both 0 and 1 FM signals, are positioned in frequency bands of adjacent channels.

1. An RF transmitter having an IF modulator for generating an IF modulated signal, and having an RF modulator, the RF modulator being arranged to generate RF signals on a number of frequency channels, from the IF modulated signal, the IF modulator being arranged to use a very-low-IF-frequency, smaller than half a bandwidth of a channel and larger than zero.

2. An RF transmitter suitable for Bluetooth transmissions and having an IF modulator (120) for generating an IF modulated signal, and having an RF modulator (150), the RF modulator being arranged to generate RF signals on a number of frequency channels, from the IF modulated signal, the IF modulator being arranged to use a very-low-IF-frequency (f_{IF}) smaller than half a bandwidth of the channel and larger than zero, such that significant spurious unwanted modulation components fall in channels having a channel number number smaller than three of a channel being transmitted.

3. The RF transmitter of claim 1, having a fractional PLL circuit for generating the RF local oscillator signal for the RF modulation.

4. The RF transmitter of claim 1, the channel bandwidth being 1 MHz or less.

5. The RF transmitter of claim 1, the very-low-IF-frequency being selected such that spurious components at frequencies based on integer multiples of a baseband frequency, in an RF output spectrum, are positioned in a frequency band of an adjacent channel.

6. The RF transmitter of claim 1, wherein the RF transmitter is a Bluetooth transmitter.

7. A transceiver having the transmitter of 1, and having circuitry for digital baseband processing, for analog IF functions and for RF modulation and RF modulation and demodulation functions.

8. The RF transmitter of claim 1, having a fractional PLL circuit for generating the RF local oscillator signal for the RF modulation.

9. The RF transmitter of claim 1, the channel bandwidth being 1 MHz or less.

10. The RF transmitter of claim 1, the very-low-IF-frequency being selected such that spurious components at frequencies based on integer multiples of a baseband frequency, in an RF output spectrum, are positioned in a frequency band of an adjacent channel.

11. The RF transmitter of claim 1, wherein the RF transmitter is a Bluetooth transmitter.

12. A transceiver having the transmitter of any preceding claim, and having circuitry for digital baseband processing, for analog IF functions and for RF modulation and demodulation functions.

13. A portable wireless product having the transmitter of claim.

14. A portable wireless product having the transmitter of claim 2.

15. A method of generating signals in an RF transmitter, comprising:
using an IF modulator to generate an IF modulate signal,
using an RF modulator to generate, from the IF modulated signal, RF signals o a number of frequency channels,
wherein the IF modulator uses a very-low-IF frequency smaller than half a bandwidth of a channel and larger than zero.
